(19) United States
(12) Patent Application Publication
(10) Pub. No.: US 2021/0179958 A1
(43) Pub. Date: Jun. 17, 2021

(54) Bituminous coal and lignite biomass fuel polyolefin and other waste plastics smoke-free combustion technology

(71) Applicant: Ailin DAI, Shanghai (CN)

(72) Inventor: Qingsheng WANG, Shanghai (CN)

(21) Appl. No.: 17/081,526

(22) Filed: Oct. 27, 2020

Related U.S. Application Data
(63) Continuation-in-part of application No. PCT/CN2019/084526, filed on Apr. 26, 2019.

(30) Foreign Application Priority Data
Apr. 27, 2018 (CN) 201810390637.4

(51) Int. Cl. C10L 10/02; C10L 5/44; C10L 5/48; C10L 5/40; C10L 5/04; C10L 5/12; C10L 11/04; F23G 5/08; F23G 5/24; F23G 7/10; F23G 7/12; F23G 7/07

(52) U.S. Cl. CPC C10L 10/02; F23G 2209/26; C10L 5/48; C10L 5/406; C10L 5/04; C10L 5/12; C10L 11/04; F23G 5/08; F23G 5/24; F23G 7/10; F23G 7/12; F23G 7/07; C10L 2200/0469; C10L 2290/24; C10L 2290/32; C10L 2290/06; F23G 2201/701; F23G 2202/60; F23G 2204/101; C10L 5/442

(57) ABSTRACT

Low carbon atomic number mixed alcohol gel paste or pancake and straw charcoal grate combination of ignition agent, with fossil fuels such as bituminous coal lignite, straw branches and other agricultural and forestry waste, polyolefin and other synthetic organic polymer waste, other combustible solid and semi-solid low-value raw fuels, with non-toxic auxiliary materials carefully crafted high volatile column ignition coal and lower coal, are stacked in the insulation—fire-resistant furnace core. Throw in a small strip of burning paper to ignite the igniter from the top, that is, start long flame combustion, followed by the ignition coal on fire, its surface red hot coal layer will be designed to move down more quickly and gradually, to the lower coal on fire.

### FIELD OF THE INVENTION

Clean and efficient combustion control technology of solid fuels; specifically, involving fossil fuels such as bituminous lignite, straw and branch and other agricultural and forestry waste, polyolefin and other synthetic organic polymer waste, combustible household waste and high-sulfur petroleum coke and other difficult to clean combustion of industrial fuels, waste secondary raw materials and garbage, to achieve zero-smoke state of clean and efficient combustion control technology, but only for non-forced combustion of stoves and furnaces.

### BACKGROUND OF THE INVENTION

From ancient times to present, the burning of plant fuels such as straw, fossil fuels such as coal, and synthetic organic polymer waste materials such as plastic and rubber fibers, regardless of whether they are burned in piles or in stoves, will emit smoke, that is, they will not burn fully.

Take the bituminous coal, for example, for more than 1000 years, all are scattered burning, exhaust gas pollution is serious, and the heat generation efficiency is low, large and medium-sized stoves and stoves are generally 50-60%, the lowest small only 20-30%. Numerous institutions have long studied the boilers and other industrial stoves and stoves molding bituminous coal combustion technology, smoke emissions, heating efficiency, solid sulfur rate and other issues have not improved significantly and terminated.

If new technology is born, in which equipment modification low investment, low cost of use, can be adapted to the forced combustion of all kinds of stoves for clean combustion of solids and semi-solids (can be defined as emissions of exhaust gas cleanliness close to natural gas), coal and all kinds of combustible solids and semi-solids, can still be used in parallel with a variety of new energy for a long time. Moreover, the use of straw and the overflow of waste plastics and rubber tyres as fuel is itself one of the reasonable and even better technological means of solving environmental pollution.

Since 2018, the success of the bituminous coal dust injection process at large thermal power plants in the People's Republic of China has been publicly reported, which has significantly improved the heat generation efficiency to over 95%, and the exhaust gas has been treated by a purification device to achieve a purification rate of over 95%, which is very close to clean combustion. The technology is very suitable for kilns that need forced combustion, and is expected to be quickly promoted to medium-sized coal-fired thermal power plants, large and medium-sized rotary kilns, tunnel kilns, smelting and glass kilns, etc., with good prospects.

But the difficulty is that in developing countries, many small and micro-enterprises are not able to burn pulverized coal, nor can they afford to install exhaust gas cleaning devices. In the case of straw-forming fuels, there is still a lot of smoke in the stage of ignition and fuel addition, and it is also a blast combustion, most of the soot blown out, still need to exhaust smoke cleaning device, and low calorific value, not burnable, the user fee is about one time more than the bulk-burning bituminous coal, difficult to sustain.

What is even more difficult is that the amount of exhaust pollutants directly emitted from the scattered institutions and the large number of people living in the scattered areas of agriculture, animal husbandry, industry, commerce and field work, who burn bituminous coal for heating and winter heating in their work, production, operation and lives, is 10-15 times more than the same amount of bituminous coal burned by large thermal power plants, and the engineering and technological circles have no good methods to deal with this problem so far.

To solve the ancient technical problems of combustible solids and semi-solids burning smoke, it is necessary to first carefully analyze the cause of smoke. Bituminous coal is used as an example.

Whether the bituminous coal is burned in bulk or formed, it is usually ignited from the lower part of the pile (lump), and the incipient high temperature zone is in the lower part. When heated up to 200-250° C., the bituminous coal starts to escape and thermally crack the volatile fraction, which contains more large molecular weight organic matter; when heated up to the ignition temperature of 270-300° C., the escape intensifies, accompanied by thermal cracking, and the thermal disintegration of the coal lump into fine powder occurs rapidly. Unfortunately, in this temperature range, the elemental sulfur, organic and inorganic sulfur and nitrogen components also decompose, oxidize and escape almost simultaneously and rapidly, resulting in the asphyxiating characteristic odor of sulfur and nitrogen-containing compounds in the thick flue gas of bulk-burning bituminous coal. This is because compared with ordinary pyrite, the thermal decomposition of coal-based pyrite has a special way: in the presence of ultrafine activated carbon powder or reduced iron powder, 200° C., according to the reaction formula FeS₂==FeS+S, the decomposition of ½ equivalent sulfur, in 300-400° C. dramatically decomposed almost all the sulfur and oxidized to sulfur oxide gas, which requires 600-800° C. with ordinary pyrite high-temperature oxidation desulfurization reaction, there is a huge difference. A serious problem is that these concentrated fugitive volatiles of bituminous coal, consisting of larger molecular weight organics, carry with them a large amount of fine powder from the thermal disintegration of the coal and new fine powder from the thermal disintegration of the coal, as well as immobilized carbon powder (commonly referred to as “smoke” due to its visible, foggy appearance, including in the present description, “Zero smoke” means that the gas, which is no longer visible to the naked eye when the combustion exhaust is discharged from the stack), the SOX and NOx gases must be cooled by the cold upper coal seam and the surrounding cold air, and will not catch fire easily, much less burn adequately, because of the narrow space inside the coal pile and the lack of oxygen supply (which is severe without air blowing). Flames that have been created are also easily extinguished. The inevitable result of this is that, from the time of ignition until the entire coal pile heats up to a red-hot period at the top, the gas in the above state contains a suffocating characteristic odor and is emitted in a dark brown smoky haze. In the middle of the process, bulk bituminous coal was added to the coal pile, and steel was used to pry loose the cake-coal pile to ventilate it, which was similar to the ignition process. The ignition was done from the side of the pile, and even from the top of the pile, because the coal could not be fully burned, and the smoke emission was also the same. Other solid fuels, such as lignite, weathered coal, grass char, agricultural and forestry waste, waste plastics, waste rubber tires, and combustible domestic and industrial waste, which tend to thermally volatilize, thermally decompose, and thermally disintegrate a large number of larger molecular weight organic matter and carbon particles at a certain temperature range, have similar discharge conditions in the ignition and heating combustion process. In a word, is the low temperature area in the upper, high temperature area in the lower, ventilation and distribution of insufficient and unbalanced, resulting in most of the time without order, insufficient combustion, exhaust gas inevitably large black smoke, sulfur smell heavy. For the exhaust gas to direct row of small micro stove stove stove, must be completely changed, that is, completely change the existing combustion method, in order to eliminate the exhaust smoke and sulfur smell.

Before the 1980s, a Japanese company had researched “upper ignition honeycomb” and recommended its patented technology to China in 1979, which was followed by an extensive research boom in China until 2005. The method, which involves ignition from the top of the pile and attempts to create a state where the high temperature zone is at the top and the low temperature zone is at the bottom, with gradual downward combustion, is correct, but none of the techniques developed can achieve a zero-smoke state with smooth up-ignition and rapid access to continuous clean combustion, let alone industrial applicability. This is because of the following misconceptions.

1, because the focus of the study is on small stove-type coal for residential indoor use and greenhouse use, for fear of smoke when ignition, only anthracite coal dare to be used for the pilot coal placed on top of the coal pile in the stove.

This is exactly the opposite. It should use all of them, at least a large proportion of bituminous coal, lignite, weathered coal, grass charcoal, agricultural and forestry waste, etc. to increase the content of volatile components other than fixed carbon to 30-40%, or even 50%, in order to produce a continuous long-flame combustion at the beginning of the ignition, and quickly form a “high temperature zone at the top of the coal pile in the large combustion chamber, low temperature zone at the bottom” state, which enables the red hot coal seam to move downward at a faster design rate.

2, use common oxidizers such as nitrates, chlorates, manganates, and peroxides mixed into the upper part of the pilot coal to assist in ignition.

This is obviously a mistake. The oxidizing agent will cause smoke when it is ignited, which will pollute the environment for a while, and the environmental effect is completely opposite to the original intention; it can only make the upper part of the coal about 1 cm slightly red, which cannot produce a long flame, not to mention a long flame and the rapid formation of a large combustion chamber with high temperature area, which has no beneficial technical effect; it also has high cost and great pressure on production, logistics and storage. Other ignitions, such as electric ignition, pouring waste oil, cooking oil, kerosene, gasoline ignition, ignition on a pile of firewood blocks . . . , even less practical.

However, it has been a common knowledge since olden times that when fuel piles such as trees are ignited, they burn slowly downwards, and the four measures of ignition method, honeycomb venting of coal-based fuel, supplementary ignition by a polythene board, and supplementary combustion by secondary air intake in the “Ignition of Honeycomb Coal” with the existing technology are still useful; Clean combustion is worth learning and using.

### SUMMARY OF THE INVENTION

(1) the technical problem solved by the present invention is: no fuel for forced heating, continue to use a variety of, especially small and medium micro stoves stove, with only a slight modification to it (focus on core replacement; only a fraction of the mini-stove stoves or complete replacement required), can be stacked into a variety of combustible solids and semi-solids and excipients carefully prepared, shaped into a column with honeycomb ventilator fuel block and ignition agent, along the “upper ignition, down to burn” mode, with the static combustion method, no air blast, no chimney height, static, orderly, long-flame, sufficient, zero smoke combustion from the moment of ignition, to achieve high heating efficiency, high solid sulfur rate, low nitrogen oxides, exhaust gas cleanliness close to that after combustion of natural gas, no purification treatment can be direct discharge, that is, in the short combustion process, to control the generation and emission of toxic and harmful pollutants. However, in the case of industrial stoves and furnaces equipped with some raw materials with high sulfur and nitrogen content, such as high-sulfur petroleum coke above 5%, waste rubber tire powder, polyurethane, nylon, polyimide, protein fibers, the exhaust gas needs a simple device to supplement the desulfurization and denitrification before it can be discharged.

(2) The technical principles and solutions to the technical problems of the present invention are (a) to (j) of the following.

(a) The use of four common knowledge and existing technologies: 1. The “upper ignition, down to burn” mode is one of the conditions to form the temperature distribution of the coal pile and furnace chamber where “the high temperature zone is at the top and the low temperature zone is at the bottom”. Immediately after ignition on the zero-smoke state of the ignition agent of the invention, a long flame burns in the large combustion chamber (7). The radiant heat propagated in 360 degree space without any difference, together with the conduction heat generated by the temperature difference inside the thin red hot coal seam formed at the top of the pilot coal (10) after the ignition, is greater than the convective heat carried away by the cold air rising, so the red hot coal seam can move down faster and gradually according to the design speed. In this way, only the amount of thermal volatilization, thermal cracking, thermal collapse, thermal decomposition and oxidation of sulfur and nitrogen-containing compounds in the sub-high temperature layer (or quasi-red-hot layer) adjacent to the upper red hot coal seam at each fraction of the time can effectively avoid the concentration of these combustible volatiles and sulfur and nitrogen-containing elements pollutants in the temperature range of 200-300-400° C. and the time period of lower ignition. It will not be fully burned in time to be absorbed by the strong alkaline sulfur solid agent and transformed into sulfate solid form to be retained in the coal pile, ash, inevitably, the appearance of the bad black smoke, providing an important condition.

2. The honeycomb vents of fuel-type coalification provide a condition for orderly and adequate combustion.

3. The use of a fire gathering board (6) above the top space of the coal pile assists in the formation of a simple large combustion chamber (7), which facilitates the rapid formation of a high-temperature zone.

4. The large combustion chamber (7) has a secondary air intake, which facilitates supplementary combustion.

(b) One of the improved technical solutions: better ventilation apertures, apertures and layout for coal.

1. The total cross-sectional area of the ventilation holes is more than 10% larger than that of the existing commercially available anthracite briquettes (called honeycomb in the south) (depending on the use of the product, the composition of the main raw materials and other factors, the highest can be 25% to 30%), in order to adapt to the demand of the high volatile rapid combustion of this invention pilot coal (10) large oxygen consumption.

2. Take the current 100 mm diameter cylindrical honeycomb briquette as an example, the diameter of several ventilation holes (13) in the central part of the briquette needs to be extra large, 2-3 mm larger than the peripheral ventilation holes (12), so that the flame beam of the torch in the center of the main hole of the fire gathering plate (6) can get a similar amount of fresh air as that of the secondary air inlet duct hole (4) in the periphery of the furnace core (2). When multiple combination units are stacked horizontally in a larger furnace chamber, the distance between the combination units in the central part is 2-3 mm larger than the surrounding units, so that the central part of the coal pile gets a secondary air intake similar to that of the surrounding parts, and the central main torch flame in the central main hole of the aforementioned fire gathering board (6) gets a sufficient amount of fresh air as an additional guarantee measure.

3. Stove stove stove lower air inlet (4) cross-sectional area than the total cross-sectional area of the coal pile inside and outside the vent hole, but also should be 5-20% larger to be appropriate, the higher the combination unit, the more the combination unit, the closer to 20%; Industrial stove stoves should be installed in the main air inlet (5) and secondary air inlet air volume automatic control device to ensure that the furnace flame is always oxidation flame form, which is very important for the full combustion of the control measures; the operator of a simple compact stove can also be experienced in controlling the air inlet to a better state. At the end of each ignition combustion, i.e. after the long flame, the secondary air inlet opening (4) can be closed to avoid the side effect of cooling down in the stove. It is necessary to make this 4-point improvement to increase the oxygen supply, so that full combustion can be ensured without the need for air blowing and without raising the chimney.

(c) Improved technical options II: Large combustion chamber (7) volume and furnace core (2) material.

1. The upper part of the furnace core (2) must have a space of sufficient size and volume, not less than the volume of one lower coal (9), to form a simple large combustion chamber (7) by covering with a fire gathering board (6). Formulations with very high volatile matter and high fixed carbon coal gasification rates also require a moderate increase in the volume of the large combustion chamber (7).

2. The height of the combustion chamber and the height of the furnace core (2) corresponding to the height of the pilot coal (10) should be modularly produced with high magnesium and low transition element content materials that have a good balance of heat retention and refractory properties and are generally alkaline. Because like the traditional stove, only consider the refractory properties of material selection, the winter cold weather small heating furnace zero smoke state smooth ignition, early formation of large combustion chamber (7) high temperature zone of the key design is very unfavorable; solid sulfur formula of coal lump was strongly alkaline, easy and acidic core at high temperature fusion, so need to be made into an alkaline core; low transition elements (coloring elements) content can make the furnace core (2) light color, good reflection for the light and heat, the ignition after the rapid warming benefits.

(d) Improved Technical Solution 3: Fire gathering board (6)

Fire gathering board (6) thickness, quality of small as good, material be consistent with insulation—refractory material of the upper part of the furnace core (2), or even color close to white better, the best, around the inlaid circle of good anti-sulfur stainless steel belt or cheap steel or steel wire to be reinforced as good, in short, so that it absorbs less heat, the inner arc face down to reflect light, heat, the more the better. For industrial and cooking stoves that require high fire power and high operating temperatures, as well as the smallest diameter coal (often 100 mm), single unit combinations, cold season ignition of the stoves, high calorific value, pilot coal (10) with this high-performance furnace core (2) and fire gathering board (6) is needed; for heating, baking dry, boiling hot water purposes in slightly lower latitudes areas, low-cost pilot coal (10) is matched with the furnace core (2) and the fire gathering board (6) could be chosen.

(e) Innovative Technology No. 1: coal reactor composition and structure

In the present invention, the stacking of coal fuel briquettes is as follows: one straw charcoal grille (11) and one ignition cake (8), one pilot coal (10), and one to three lower coals (9) are placed in the furnace core (2). If ignition paste is used, after placing the lower coal (9) and the pilot coal (10), temporarily squeeze it on the top of the pilot coal (10) before ignition and ignite it immediately. Multiple combinations of units can be ignited horizontally, if desired, which naturally need to be matched with the furnace chamber, the furnace core (2), the grate (15), and the fire gathering board (6). When multiple combination units are used in a large furnace chamber, the low dosage of the ignition agent can moderately reduce the cost and increase the temperature quickly, with obvious beneficial effects because “the flame is high when everyone gathers wood”.

(f) Innovative Technology No. 2: ignition paste, ignition cake (8) and straw charcoal grille (11)

1, ignition paste, cake combination, matching pilot coal (10) and lower coal (9), after ignition can quickly form a large combustion chamber (7) high temperature zone, is the most important core technology of the present invention, this is a relatively safe solid, semi-solid non-toxic ignition agent, completely replace the oxidizer ignition, can be ignited from the moment of ignition to zero smoke state to ignite a long flame. Combined with the improvement of technical measures such as supporting stove cores, poly-fire plate, secondary ventilation, cross-sectional area and layout of ventilation holes of coal blocks, stacking and placement of coal blocks, the whole process of combustion from the instant of ignition can be successfully realized with zero smoke, low carbon monoxide, low volatile organic compounds, low sulfur oxides, low nitrogen oxides, and low solid particle emissions, so that the combustible solids and semi-solids can finally reach the degree of cleanliness of combustion exhaust close to the level of natural gas.

2, Ignition paste is more suitable for the combination of more units of the stoves, ignition cake (8) is suitable for the combination of units 1-4, but there is no clear technical regulations on the use of the two, the consumer to choose. The thin cake is easy to break, especially the large diameter, so it is a little inconvenient, but after the break can still be used, the ignition effect does not affect much. Paste product extrusion volume control needs to be careful not to overdo it, after skilled use, can save ignition costs.

3, (I) The selection of low-carbon atomic number mixed alcohol gels as ignition paste and ignition cake (8) renders the right technical concept for forming solid fuels, “ignite up, burn down”, which is at the same time novel, advanced and industrially practical to enter the practical phase. (II) This is slightly less expensive than ethanol alone. (III) The mixed alcohols also create an incremental burn which extends the valuable burn time of the ignition agent. (IV) The gel also has one of the greatest key beneficial technical effects: the gel melts quickly from heat after ignition because of the large number of micropores in the pilot coals (10) and the fact that the surface of the solid particles is made to be both hydrophilic and lipophilic, consistent with the alcohols used, and because the ignition paste is also hydrophilic and lipophilic on the surface of the solid particles in the straw charcoal grille (11) on top of the ignition cake (8). The ignition paste and the ignition cake (8) can quickly adsorb the burning gel liquid both at the top and bottom after ignition, and soon a good situation of three-dimensional combustion and long-flame combustion occurs, which is very favorable to the formation of a large combustion chamber (7) high-temperature area, which has been repeatedly confirmed by the inventors in numerous ignition tests and demonstrations.

4, Low carbon atomic number mixed alcohols of the present invention, (I) typically includes 2-9 carbon atoms; (II) Unlimited number of carbon chain structural isomers and alcohol hydroxyl groups and isomerization, i.e., aberrant tertiary, also including the use of ethanol alone with or without water, including the use of isopropanol alone with or without water; (III) although methanol has similar technical effect and lower cost, it can also be included, but because of its high toxicity, the present invention does not advocate the widespread use of small and micro stoves, which are suitable for industrial stoves with good equipment and plant management conditions; (IV) The main considerations when formulating: flash point, ignition point, melting point, volatility, all should have a gradient, so that within 2-3 minutes after ignition ignition, a progressive combustion can be produced, extending the ignition agent's extremely valuable long-flame burning time; (V) In gel production, the minimum temperature difference between the safe dissolution of the gelling agent and the paste and gelling temperature should be greater than 20° C., preferably 30° C., to facilitate the casting operation; the maximum temperature is generally controlled at 70° C., for fire fighting safety; (VI) If high temperature and fluctuations were observed on ignition cake (8) during storage period, the gel will evaporate and precipitate a small amount of irreversible liquid alcohol, so it should be stored in a cool, ventilated warehouse.

5, (I) The straw charcoal grille (11) is an important add-on specially designed to assist ignition, reduce ignition cost and improve ignition reliability for small and miniature cold stoves in high and middle latitudes and at altitudes above 2,000 meters in cold winter weather; (II) After ignition, the straw charcoal grille (11) will quickly burn itself red and become the thermal insulation layer of the pilot coal (10), when the ignition paste or ignition cake (8) is about to burn out, the long flame is shortened, and may cool down and extinguish the fire, the crisis approaching, maintaining the pilot coal (10) in the upper hot zone flame is not excessively shortened, and hold on to the long flame until later resurrection; (III) The flame is an incomplete plasma, carrying more energy, which is very favorable for the generation of strong radiation in the large combustion chamber (7) and the high-temperature zone of the furnace, so that the maintenance of a long flame is a very important condition for the rapid formation and continuation of the “ignition up, buring down” state; (IV) The straw charcoal grill flame cross-channel, described as reference sign 14 in FIG. 2, is used to increase successful ignition up: after squeezing the ignition paste or placing the ignition cake (8) on the top surface of the pilot coals (10), immediately place the straw charcoal grille (11), cover the fire gathering board (6) and drop a small burning cigarette strip through the center hole of the grill, which will probably ignite at least one spot of the ignition paste or ignition cake (8), the flame will spread around these cross-channel and quickly ignite the entire surface of the ignition agent.

6, Combining the ignition cake (8) with the straw charcoal grille (11) is more convenient to use, and has been developed as one of a series of igniters in this invention, which is very useful, please watch for a later patent application by the inventor and applicant. But the production of this variety, only a single piece of hot casting, in slightly higher latitude areas, winter production, alcohol volatile loss is small, the workshop fire problems is also not big, is still convenient.

7, Ignition cake (8) is produced by casting into a long column, and after cooling and demolding, each long column of gel rods can be sliced at once, with less volatile loss of alcohols and less fire fighting pressure. In non-cold weather, warm stove ignition, more combination unit ignition, without straw charcoal grille (11), the use of 4 mm sheet alone can be enough, ignition cost is not high, but also more convenient.

8, Expensive beta-cyclodextrin-coated alcohol-based igniters were not selected as igniters, primarily because the gels could produce the steric burn ignition described above, and secondarily because of the low cost of the gels.

9, In short, the three parts of igniters, namely ignition paste, ignition cake (8), and straw charcoal grille (11), can be selected by consumers according to their specific situations and wishes, and combined separately for flexible use.

10, The binary design of the ignition agent and pilot coal (10), separate transportation, storage, and help reduce the fire pressure, which is very important. The ignition coal (which is used to ignite ordinary anthracite briquettes, and which has to be stored outdoors) is flammable, and it is dangerous to store it in large piles. The pilot coal (10) of this invention cannot be easily ignited by a match or lighter, but is combustible. Although ignition paste and cake are flammable products, their volume and weight are generally only 10-15% or less of the pilot coal (10), and they are easily and safely transported and stored in boxes and crates. In addition, pilot coal (10) need to be heated and dried, ignitant without the need for this is not allowed.

(g) Innovative Technology No. 3: the formulation and production process of an ignition paste, an ignition cake (8) and a top-mounted straw charcoal grille (11), as well as the packaging method (the technical parameters of which are not limited to this scope), please see V, specific examples (1), (2), (3).

(h) Innovative Technology No. 4: Pilot coal (10) This is an important structure between ignition paste, cake (8) and lower coal (9), which mainly relies on the heat it releases to form the high temperature area of the large combustion chamber (7) at the top of the coal pile, and successfully and smoothly ignite the lower coal (9), so it is required to achieve orderly, full and long-flame combustion in the process of rapid combustion and temperature rise. Let the red and hot coal layer move down gradually according to the design speed, so that no black smoke and very little gas with asphyxiating characteristics and strong irritating smell of sulfur oxide can be escaped during the whole burning process of coal block.

The technical principles utilized and the technical measures taken in the making of the pilot coal (10) and the lower coal (9) of the present invention in order to achieve orderly, adequate, long-flame form combustion are as follows.

1, the ignition point of each fuel component has a suitable gradient from low to high, they are straw and other agricultural waste, fallen rosin, industrial waste wax, lost wax casting waste wax (containing stearic acid), waste polyolefin plastic, lignite, weathered coal, bituminous coal, coal slurry . . . coke surface in that order.

2, there must also be a suitable particle size distribution between each fuel component according to the fineness.

3, each component itself also has a reasonable particle size distribution. For example, bituminous coal passes all 30 mesh sieve, naturally including nano, micron and millimeter particle size distribution; lignite passes all 20 mesh sieve, particle size distribution is similar to bituminous coal; waste polyolefin plastic sheet is less than 2 mm, containing a small amount of fine particles; agricultural and forestry waste particles are less than 3 mm, with a large amount of fine powder of their own.

4, lignite, weathered coal, grass charcoal, larch, lost wax casting and other industrial waste wax waste stearic acid, waste grease and other raw materials containing complex structure of large-molecule organic acids, reasonable matching, the use of KOH liquid saponification of part of its large-molecule organic acids to form an emulsion, and then add into the waste plant particles appropriate boiling method, together to form a production process by the way of self-produced coal powder and other auxiliary materials powder of cheap organic binder. This is beneficial to reduce the ash content, improve the calorific value of the formula, and maintain the mechanical strength of the coal block in cold, wet and hot state. This effectively avoids black smoke when burning large organic compounds containing thick rings, and significantly reduces carcinogen 3,4-benzopyrene.

5, in addition to the raw material state described in paragraphs [0032], [0033], [0034], [0035], the pilot coal (10) formula must also have high volatile characteristics, which is an important technical solution to maintain most of the time long flame combustion. In this specification, the volatile content of fossil fuels such as bituminous coal and lignite, together with synthetic macromolecular organic matter such as agricultural and forestry waste, waste plastics, and other combustible organic products are included in the total volatile content; according to the different uses of the product, it is desirable to keep the total volatile content of the pilot coal (10) formula at least 30%, generally 40%, or 50% if there are special requirements, but too high a volatile content will lead to too low of ash content, and it is easy to collapse the ash and block the ventilation hole in the middle of combustion. In addition, the lower coal (9) contains a moderate proportion of volatile matter, such as 20-30-40%, will be conducive to the smooth connection of fire and maintain a long period of long flame combustion.

6, first, by the agricultural and forestry waste particles first combustion, other volatile components and nanoscale carbon successively combustion resulting in the pilot coal (10) and the lower coal (9) of the red hot coal seam has formed a considerable number of microporous as fixed carbon micro coal gasification reaction generator and gas combustion chamber, which will greatly increase the amount of gasification combustion, conducive to increasing the long flame combustion time; second, gas through the red hot coal ventilation holes (12) and (13) as a small combustion chamber to continue to burn, and then through the large combustion chamber (7) largely complete full combustion, and finally in the main torch accompanied by secondary and tertiary air intake to supplement the combustion (industrial stove stove air oxygen excess coefficient control for 5-10%, flame control for the oxidation state), by this 4-stage continuous combustion, is to achieve full combustion of another guarantee conditions.

(i) Innovative technology No. 5: a heating coal (10) formula, production process and packaging (and not limited to its technical parameters only so range) are as follows: 100 mm diameter cylindrical pilot coal (10), for example, ingredients: dry base 200 g each, heat (5000-5300)×4.1868 kJ/kg more appropriate, divided into two layers, two additives, a hydraulic forming is appropriate. Please see V, specific implementation (4).

(j) Innovative technology No. 6: Lower coal (9)

This type of coal block is the mainstay for providing most of the heat generation and the cost per unit mass is lower than that of igniter and pilot coal (10). Besides considering that it can be ignited smoothly by the pilot coal (10) and continue to maintain long flame combustion, the focus is to match the raw materials with low price/unit heat generation and can be procured nearby, such as coking surface other than bituminous coal, lignite, agricultural and forestry waste, waste synthetic organic polymer materials such as waste plastics, coal sludge, coal chemical and petrochemical industries with low price and waste materials, which are more flexible. In terms of breeding, agricultural products processing and other industrial enterprises and the diaspora population heating, heating, boiling hot water with stove stoves, because the original bulk burning bituminous coal, agricultural and forestry waste when the furnace is larger, can be placed more coal block combination unit, so the heat requirements are not necessarily high, but want to use low cost, you can design the formula according to (3 800-4000)×4.1868 kJ/kg. Only for those who require large fire power, it is designed to 5000×4.1868 kJ/kg or more.

Lower coal (9) forming pressure is larger, also can only add inorganic binder, no need to dry. It is better to keep 5-10% moisture before the coal briquette goes into the furnace, which can improve the gasification rate of fixed carbon. A recipe and production process please see V, specific implementation (5), again, the technical parameters are not limited to the scope of this specification.

Low carbon atomic number mixed alcohol ignition agent, fine formulation and production process of coal block measures, with the new stove core and poly fire plate, secondary or even three air intake structure, formed by “up ignition, down combustion” “high temperature zone in the upper, low temperature zone in the lower” static, non-blowing combustion mode, together constitute an orderly, long flame, moderate oxygen-rich, full combustion of the full—necessary conditions, and finally achieve clean and efficient combustion effect.

(3) The beneficial effect of using the technical solution of the present invention is: \textcircled{1}, because from the moment of ignition at the top of the longitudinal combination unit of the low carbon atomic number mixed alcohol gel igniter, pilot coal (10) and lower coal (9) placed in the core of the special stove, the long flame combustion starts with zero smoke and in an orderly manner, and the high temperature zone is formed first in the large combustion chamber (7) at the top of the coal pile; because the ignition can form a continuous, more stable long flame combustion sooner because of the continuous and stable long-flame combustion after ignition, the radiation and conduction heat absorbed by the red-hot coal seam on the surface of the pilot coal (10) is greater than the convection heat taken away by the cold air rising, and it can move down more rapidly according to the design speed; due to the careful design of the formula components of the pilot coal (10) and the state of existence, therefore, in any microfraction time, only the immediately adjacent coal seam at the lower end of the red-hot coal seam reaches the second-high temperature and the volatiles escape microfractionally. They are burned in the micro-hole of the red-hot coal seam, and then enter the red-hot ventilation hole to continue to burn, and the gas reaches the large combustion chamber (7) and completes the full combustion, and finally is burned out in the central main torch of the fire gathering board (6) with the supplementary air inlet and secondary air inlet brought by the inner ring ventilation hole (13). It is a clean and efficient combustion effect with zero smoke, low sulfur oxides, low nitrogen oxides, low solid particulate matter, low VOC emissions, high solid sulfur rate and high heat generation efficiency in the whole combustion process.

\textcircled{2}, The pigment-grade iron oxide red with a mass ratio of 50 nanoparticles of 10% or more is selected to replace the expensive ferrocene as a cheap catalyst for the water gasification reaction and combustion reaction between the fixed carbon formed by the numerous micropores and ventilation holes inside the red hot coal bed and the intramolecular and extramolecular water inside the coal block, which greatly increases the long-flame combustion time.

\textcircled{3}, As the ignition agent of the present invention and the pilot coal (10) in close cooperation, already has excellent ignition effect, thus completely abandoning the toxic, dangerous and expensive oxidizer formula, that is, not to use nitrates, chlorates, perchlorates, manganates, permanganates, manganese dioxide, inorganic organic peroxides, nitro compounds, nitrocellulose. The invention formula also strictly rejects the use of heavy metal elements containing lead cadmium arsenic mercury cadmium thallium beryllium and excessive radioactive raw materials, and strictly rejects the use of toxic and harmful raw materials such as halogens, so as to reduce the production, sales and use of the link personnel poisoning, only the emission of clean exhaust gas, burning slag can be used.

\textcircled{4}, Burnt slag less, generally controlled at 10%45%, the structure is more relaxed, but the burning does not collapse, after the end of burning light pounding can fall into the slag collection tank, which is important for continuous operation of industrial stoves stoves; burnt slag contains potassium, calcium, magnesium, iron, silicon and sulfur fertilizer elements, is slightly alkaline, with organic fertilizer, for fertilizer and acidic clay mass structure improver is very suitable, can also be used as raw materials for building materials such as cement.

\textcircled{5}, Due to the binary design of flammable ignition cake (8) and combustible pilot coal (10), they are transported and kept separately, which reduces the pressure of firefighting. A match or lighter to directly ignite the fire, not easy to ignite the pilot coal (10).

\textcircled{6}, The strong smoke elimination mechanism makes various low-value, carbon-hydrogen (and oxygen) containing waste solids and semi-solids, as long as they do not contain toxic and harmful substances as described in paragraph [0044], can be incorporated into the formulation of the present invention and more ideally digested as a clean fuel. The raw fuel containing both higher sulfur and nitrogen elements can be dispensed into the lower coal (9) in a larger proportion to reduce the cost of the product, but the exhaust gas is not directly emitted and is discharged after purification by a desulfurization and denitrification device, so it is suitable for use in industrial stoves with detection and control equipment.

\textcircled{7}, The products of the technology of this invention are mainly applicable to small and medium-sized micro-type stove stoves that do not require forced combustion; they are suitable to be combined with straw power plants, garbage incineration plants, and thermal power plants below 300,000 kilowatts that are required to stop the use of power generation, and benefit to make them smoothly transformed into low-pressure steam supply plants with good technical, environmental and economic benefits, and can be operated according to the market model.

### BRIEF DESCRIPTION OF THE DRAWINGS

FIG. 1 shows the product of the invention takes the most difficult small size coal block and the supporting stove, which is the most difficult to achieve “upward ignition and downward combustion”, as an example, to explain its combustion mechanism, it is the main drawing and also selected as the summary drawing;

FIG. 2 is the top view of the combination of the ignition cake (8) (with round pattern) and the top-mounted straw charcoal grille (11) (with bar pattern), and A-A section view showing straw charcoal grate fire cross channel (14) whose position and size may be adjustable neatly and safely.

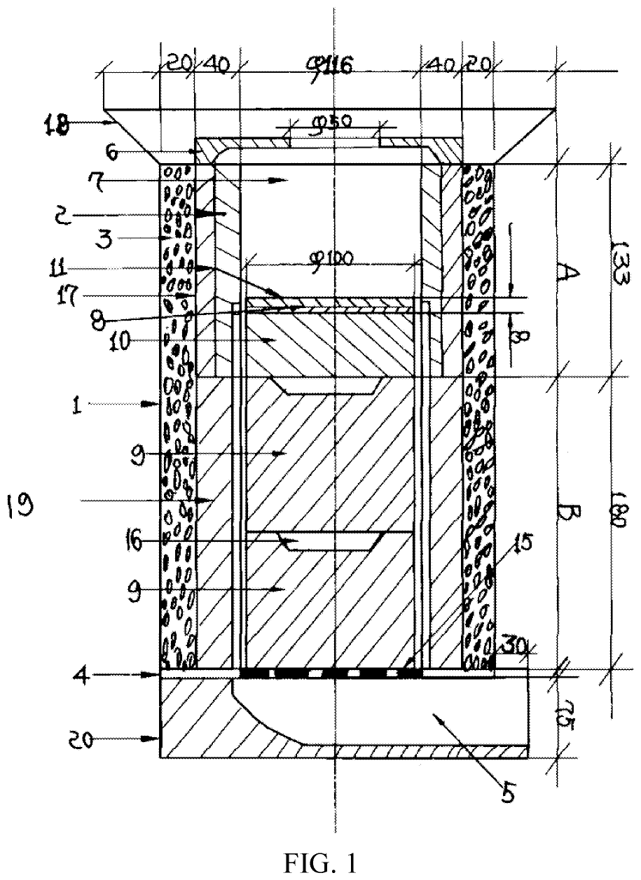

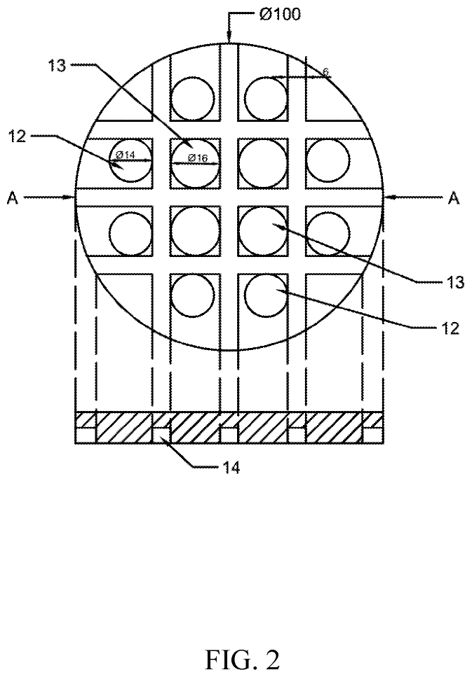

In FIGS. 1 and 2, the names of the icons are as follows.

1, furnace wall 2, furnace core 3, insulation layer 4, secondary air inlet duct 5, main air inlet and ash outlet 6, poly fire plate 7, large combustion chamber 8, ignition cake 9, lower coal 10, pilot coal 11, straw charcoal grate 12, outer ring ventilation hole 13, inner ring ventilation hole 14, straw charcoal grate fire cross channel 15, cast iron grate.

The technical parameters of the formulations and production processes illustrated in each specific implementation cannot be limited to this range only. (1) An exemplary formulation of an ignition paste is as follows: a, isopropyl alcohol 46%, b, ethanol 20%, c, ethylene glycol 5%, d, calcium oleate 3%, e, magnesium oleate 1%, f, calcium stearate 3%, g, magnesium stearate 1%, h, water 21%.

The production process is as follows: in 0.5 cubic meters of porcelain enamel jacketed anchor stirring reaction kettle, put a b c, turn on the stirrer, low speed, turn on the jacket steam slowly to 60° C., while gradually adding gelling agent de fg in stages, and finally slowly adding combustion rate inhibitor and gelling temperature speed regulator h. Sample testing, into the paste point 46±2° C. that is qualified, keep at 55-60° C. into 200-500 grams of PVC toothpaste tube, screw cap sealing, natural cooling to normal micro temperature, 10 kg corrugated carton packaging.

Because this ignition paste is a flammable product, so the layout and construction of the workshop, laboratory test and inspection room and storage room, workshop equipment and various wiring installation, personnel training, etc., all in accordance with the strict implementation of fire codes, the following ignition cake (8), the same as this.

(2) An example of an ignition cake (8) is formulated as follows: a, isopropyl alcohol 46%, b, ethanol 20%, c, ethylene glycol 5%, d, water 20%, e, sodium stearate 5%, f, magnesium stearate 3%, g, calcium oxide fine powder 1%.

The production process is as follows: in the same equipment as the production of ignition paste, put a, b, c, open the lowest stirrer, turn on the jacket steam to slowly increase the temperature, while adding gelling agent e, f, the kettle material temperature to 60° C., turn off the steam, to be almost transparent liquid, slowly add combustion rate inhibitor cum gelling temperature speed regulator d, and finally sprinkle into the supplemental hardener g, and allow the temperature to rise to 70° C. Take a sample to determine the gelation temperature, it should be higher than 40° C.; keep 50-60° C., start casting, after casting, spray cold water to the outer wall of the mold cylinder, after the material temperature inside the cylinder drops to below 35° C., take off the mold and slice. Use the least permeable polyacetate (cellophane) film bag among common plastic films to encapsulate single piece, and then pack in 5 kg plastic drum or thin tin drum for storage. It is necessary to pay attention to the casting discharge pipe and pipe fittings, both must be well insulated to prevent condensation blockage. The maximum allowable temperature for logistics is 38° C.

(3), an example recipe and production process of straw charcoal grille (11) are as follows: add 100 kg of straw or pine or fir or sisal wood completely carbonized product with 10 mesh sieve to the mixing machine, and 15-20% concentration of potassium water-glass above 2.8 modules, the quantity is 6% of carbonized product in dry basis, and 3 kg of calcium oxide fine powder, mix well and transfer into the hopper of the molding machine, and mold into this machine. The straw charcoal grille (11) shown in the attached FIG. 2 of the instruction manual, placed in a well-ventilated simple warehouse type workshop for natural drying, and then packed into the warehouse in two levels of ultra-thin plastic bags and corrugated cartons.

(4), an example recipe and production process for a pilot coal (10) is as follows: The above proposed 100 mm diameter, 200 g dry basis, heat content (5000-5300)×4.1868 kJ/kg pilot coal (10) is used as an example, and its double-layer material recipe and production process are as follows (the first part of the parameter is the amount of the upper-layer material recipe, and the parameter in parentheses is the amount of the lower-layer material recipe).

a, Pine sawdust 20 kg (15 kg) b, Peanut shell powder 5 kg (9 kg) c, Larch 9 kg (4.5 kg) d, Lost wax casting waste wax 9 kg (4.5 kg) e, Potassium hydroxide 3.2 kg (1.6 kg) f, Bituminous coal, 6000×4.1868 kJ/kg, 35% volatility, 60 mesh full pass 18 kg kg, 25 mesh all over 30 kg (same grade as before, 25 mesh all over, 65.85 kg) g, calcium oxide fine powder 3.5 kg (5 kg) h, 40% potassium water glass 5 kg (8 kg) i, water 40 kg (35 kg) j, pigment iron red 0.3 kg (0.35 kg).

Above a demonstration stove for boiling water in a small enterprise using nine 100 mm diameter coal piles of the product of the invention, an iron pot with an open flat bottom and a paddle stirrer is placed, i is added, the fire is heated up, the lowest speed stirring is turned on, e and c are added, branches, leaves, insects, stones and other debris in c are selected by hand, and d is added; when the temperature in the pot is close to the boiling point, the dissolving and emulsifying operation should be completed. Open the bottom side of the pot orifice laid with filter wire mesh discharge tube valve, while hot filter out the emulsion, let it flow to the kneading pot with steam heating jacket, the pot has been added a b; put material after, open the kneading and steam to a b completely wet, close the kneading, insulation 15-20 minutes; add prior to have been in the dry mixer with a uniform f g h j, kneading 15-20 minutes, until the material is completely mixed; push the kneading material to the hydraulic molding machine No. 1 hopper, this is the upper part of the pilot coal (10) material. Another set of the same system is equipped with the lower part of the pilot coal (10), which is pushed to the hopper of the hydraulic molding machine No. 2. When the hydraulic molding machine is turned on, an equal amount of No. 1 and No. 2 materials are pushed into the mold barrel in turn while it is hot, compressed and formed at one time, and then transferred into a large low-temperature air-drying room while it is hot, where the pilot coal (10) is dried at 60° C. until the moisture is less than 5%, and then moved out to the natural cooling section of the workshop together with the railcar, and when the temperature is lowered to below 35° C., each pilot coal (10) is packed into an ultra-thin polyethylene plastic bag and then packed into corrugated carton into storage. Forming pressure according to product varieties, specifications, carefully adjusted to maintain the appropriate crispness, conducive to the ignition stage of rapid temperature rise and fixed carbon gasification reaction, the pursuit of high mechanical strength is not appropriate. The aforementioned formula, there is enough adhesion, adjust the molding pressure, the mechanical strength of the product wet, cold and hot state can adapt to the production, normal logistics operations and use.

(5) Lower Coal (9)

Lower coal (9) has been formed at the upper end of the high temperature zone, easy to smoothly catch fire, the formula is more flexible, and its focus has shifted to the use of cheap raw materials, but still must pay attention to the reasonable state of its components and particle size gradient distribution, so that the long flame combustion period as long as possible; into the furnace with 10-15% moisture is very favorable to the fixed carbon coal gasification reaction (in addition, water can be stored in the slag collection tank below it to continuously produce water vapor).

A heating supplies example formula and production process points are as follows: a, straw crushed particles 10% b, pine sawdust 10% c, 20% potassium water glass 8% d, bituminous coal powder (5500×4.1868 kJ/kg, 30% volatile content, sulfur 2.5% or less can be) 68% e, calcium oxide fine powder according to the equivalent, using 3 times the sulfur equivalent f, pigment iron red 0.5% g, polyolefin waste plastic fragments 5% h, water 5%.

The d having fineness 25, and moderate particle size a, b, g, measured into the mixer, after about 10 minutes of mixing, and then add already 10 times the weight of d, a and b prior to the initial mixing of e and f, continue to mix for a few minutes, spray in c, and then mixed for a few minutes, moved into the hydraulic molding machine hopper, with greater pressure molding, down the line into storage, and let it dry naturally into storage.

The formulas and manufacturing processes exemplified in the specific embodiments are intended only to further illustrate the content of the invention, but are not limited to it, and are included in the scope of the invention as long as the following technical elements are used in the “top ignition, downward burning” forming fuel: 1, where low carbon atomic number alcohol gel paste and cake (8) are used as ignition agents, and where straw charcoal and other plant charcoal grids are used as auxiliary ignition agents, regardless of their formulation, production process and packaging form adjustments; 2, pilot coal (10) formula and molding process, as long as a, the use of 30-40%-50% high volatile ingredients b, each fuel component ignition point and particle size are arranged in a gradient to facilitate orderly sequential combustion c, with lignite and other materials containing large molecules of organic acids after partial saponification, emulsification (and potassium hydroxide and other neutralization reaction), and potassium hydroxide, calcium oxide fine powder, grass ash and other alkaline boiled agricultural and forestry waste particles, together constitute a fuel and bonding agent, regardless of its formula, production process and packaging form how to adjust; 3, commercial ferric oxide with a particle size of 50 nm or less containing at least 10% of ferric oxide is used to catalyze the re-burning of part of the fixed carbon in the coal component after gasification in the micro-pores and ventilation holes of the red-hot coal seam to facilitate the extension of the long-flame burning time; 4, the furnace core (2) at least in the pilot coal (10) bottom to the bottom of the fire gathering board (6) height, as well as the fire gathering board (6) itself, the use of better insulation properties containing high magnesium, low transition elements of light-colored, alkaline refractory material made of; 5, the total area of the air inlet of the stove and the ventilation hole of the coal block is enlarged by 10-20-30% compared with the original one made of anthracite coal, and the diameter of the ventilation hole of the inner ring (13) is larger than that of the ventilation hole of the outer ring (12); 6, the raw materials are tested to be free of excessive radioactive elements, free of lead, cadmium, arsenic, mercury, cadmium, thallium and beryllium, free of halogens, more sulfur and nitrogen, and other toxic and harmful substances, and thus the burning of burnt slag containing mainly potassium, calcium, magnesium, iron, silicon, sulfur and other elements and used as fertilizer; 7, all kinds of combustible solids and semi-solids, including their low-value waste, can be used as formula fuels in accordance with the method described in this specification to achieve efficient and clean combustion, so they are included in the content of the present invention.

1. Fossil fuels such as bituminous coal and lignite, agricultural and forestry wastes such as straws and branches, waste plastics such as polyolefins and other combustible solid and semi-solid wastes are pre-treated with non-toxic auxiliary materials, mixed, molded, and then stacked in stoves that are limited to non-mandatory combustion uses, and the molded fuel (hereinafter referred to as ‘molded coal’) static and non-blowing and ignite up way of combustion using the stove stoves in the group stack, to achieve the whole zero-smoke state, high sulfur fixation, clean and efficient combustion, exhaust gas can be directly exhausted (except for garbage and other waste fuel itself contains high temperature can be volatile toxic heavy metal elements and the case) technology, compared with the existing scattered stoves, disorderly combustion of these solid fuels, emissions of a large number of smoke, thermal cracking and thermal disintegration of toxic and harmful substances produced and not fully burned technology, its characteristics are: integration of the following 14 technical principles, programs, measures and methods to achieve these beneficial technical effects, namely—
(1) The general technical principle is that coal is fully (completely) burned in a static, non-blowing state, controlled as an orderly, oxygen-rich 5-10% condition throughout;
(2) The four methods and technical measures of the existing “upper ignition honeycomb coal” technology that are not claimed but used are \textcircled{1} upper ignition method, \textcircled{2} longitudinal stacking method with the ignition layer of the molding fuel on top, the pilot layer in the middle and the main combustion layer on the bottom, \textcircled{3} a large combustion chamber formed with the aid of a gathering fire plate on top of the supporting stove, and \textcircled{4} a secondary ventilation structure;
(3) selection of mixed alcohol gel pastes or gel pancakes (8) with low carbon atomic numbers of 2-9 carbon atoms either alone as an ignition agent or in combination with straw charcoal grille (11) respectively as an ignition agent;
(4) The fuel used for the pilot coal (10) must contain a high volatile content, with a suitable range of 30-40-50%, while the lower coal (9) may have an unlimited range, but a suitable range of 20-30-40%;
(5) the ignition point and particle size of each fuel component of the pilot coal (10) and the lower coal (9), and the particle size of each component itself, shall be distributed in a gradient according to the principle of producing a progressive combustion effect;
(6) Potassium hydroxide is used to saponify lignite, weathered coal, peat and other ingredients rich in macromolecular organic acids to form calcium, potassium and sodium salts of humic acid and other macromolecular organic acids with alkalized plant fibers to form a self-produced inexpensive organic binder for pilot coal (10) and lower coal (9), and helps to reduce the ash content of the formula (compared with inorganic binder), increase the calorific value of the formula, and delay the reduction of the calorific value of the coal during the storage period due to the coating of all coal powder (anti-dropout);
(7) selecting pigment iron red with particle size below 50 nm with a mass ratio of 10% or more to replace expensive ferrocene as coal water coal gasification catalyst and combustion catalyst to facilitate long time and long flame combustion;
(8) the principle of high sulfur fixation rate and sulfur fixation agent formulations are characterized by—\textcircled{1} coal-based sulfur iron ore thermal decomposition has a special way, that is, in the presence of ultra-fine activated carbon powder or reducing iron powder, which are strong reducing agents, the temperature as low as 200° C., the reaction formula FeS₂==FeS+S take place, decomposition of ½ equivalent sulfur, at 300-400° C., the rapid decomposition of almost all the sulfur, followed by oxidation of sulfur oxide gas, there is a huge difference comparing with oxidation desulfurization reaction with ordinary sulfur iron ore which requires 600-800° C. high temperature; \textcircled{2} traditional scattered, disorderly combustion of sulfur-containing fuel way after ignition, in this temperature range, elemental sulfur, organic, inorganic sulfur-containing, nitrogen-containing components almost with thermal cracking, thermal disintegration generated and failed to fully combustion of macromolecular hydrocarbons and fine carbon powder synchronous rapid decomposition, escape, so that the tail gas of scattered bituminous coal thick smoke entrained with sulfur-containing nitrogen-containing organic matter asphyxiating characteristics of bad odor; \textcircled{3} the formed coal contains and adds a part of fine coal powder and charcoal powder, which met the condition of decomposing sulfur at 200-300-400° C., but because of the orderly and progressive downward movement of the red hot coal seam, the elemental sulfur is decomposed and oxidized in a differential way (not in a sharp way), and also because of the 3-5 times high equivalent ratio of sulfur fixing agent calcium oxide and sodium and potassium, and evenly mixed with coal combustion powder, so most of the sulfur oxide is neutralized and becomes calcium sulfite, sodium and potassium, and then oxidized to sulfate fixed in the cinder; \textcircled{4} the reason why it is appropriate to choose 3-5 to 1 ratio between the amount of calcium oxide and the total sulfur in the fuel is that some of the calcium oxide will be consumed in combination with silica-oxygen groups, macromolecular organic acids and other acids;
(9) The design ash content of the pilot coal (10) and lower coal (9) is 12-15%, plus the chemical composition of the ash control, furnace temperature control, burning slag in a static, non-blowing combustion mode, not only to maintain the shape of not collapse blocking the ventilation holes, but also because of the dense, moderate strength, after burning only a slight pounding can fall into the ash collection tank, less dust, and burning slag non-toxic, slightly alkaline (water leachate PH value be controlled at 7-8), containing calcium and sulfur (gypsum form), potassium, magnesium, iron, silicon and other useful elements, mixed with composted plant fertilizer, acid clay agglomerate structure improver and fertilizer, or cement and other building materials used as raw materials;
(10) the characteristics of the heat releasing main lower coal (9) are \textcircled{1} because of the formation of the upper end of the high temperature zone, it is easy to smoothly catch fire, so the formula is more flexible, focusing on the selection of cheap fuel, \textcircled{2} a variety of technical measures to control the achieved reasonable assignment of components such as volatile proportion, particle size distribution, the composition and forming-method of the bonding agent, the selection and the ration of the fixed carbon coal gasification catalyst, high solid sulfur principles and carbon powder lime addition measures, ash content of the burner, etc., basically the same as the pilot coal (10), \textcircled{3} long flame, full combustion needs as much water gasification of fixed carbon as possible, so the total moisture inside and outside the molecule when it enters the furnace to maintain a quality ratio of 5-8% is good, and put water vapor in the ash collection tank to maintain continuous and stable water gasification of fixed carbon;
(11) \textcircled{1} the total area of ventilation holes of formed coal, compared with the current burning anthracite coal type, is expanded by more than 10%, or even 25-30%, which is adjusted according to the product usage and fuel composition, in order to meet the demand of high oxygen consumption for rapid combustion of high volatile fuels, and to expand the ventilation holes mainly in the central part of the cross-section, which can be directly derived from the attached FIG. 2, the area of the inner circle ventilation holes (13) is 30% larger than that of the outer circle ventilation holes (12), \textcircled{2} when stacking multiple combination units laterally in a larger chamber, the distance between the combination units in the central part is 2-3 mm larger than the surrounding units, \textcircled{3} the area of the main air inlet cum ash outlet (5) in the lower part of the stove stove is 5-20% larger than the area of the ventilation holes of the existing smokeless briquette burning stove stove, and the higher and more the combined unit, the closer it is to 20%, \textcircled{4} industrial stove installation into the air volume automatic control system, to ensure that the combustion process out of the flame is always oxidation flame form, the excess oxygen supply coefficient 5-10% is more moderate, with these four measures to increase the amount of oxygen supply, which is one of the conditions of no blower, no high chimney to achieve full combustion;
(12) the whole or large combustion chamber (7) of the furnace core (2) plus the pilot coal (10) corresponding to the height part, and the fire gathering board (6) are matched with the type coal, \textcircled{1} white and light-colored materials with high magnesium and low transitional element composition, which emphasize heat preservation and fire resistance are used for modular production, the inner wall of the two should maintain a certain degree of smoothness to facilitate the reflection of light and heat, which is necessary for the cold weather ignition on small miniature cold stove stoves, and to assist in the rapid formation of a large combustion chamber after ignition (7) high temperature zone, \textcircled{2} the overall alkaline core (2) can avoid bonding alkaline slag, and the volume of the large combustion chamber (7) is suitable for the volume of a lower coal (9), which is a suitable space necessary to achieve full combustion of gas;
(13) the coal pile combination structure and combustion method is—\textcircled{1} each combination unit from the top to the bottom: one of the straw charcoal grille (11), one squeezed into the ignition paste or ignition cake (8), one pilot coal (10), the lower coal (9) 1-3, the larger chamber can be stacked horizontally arbitrary multiple combination units; \textcircled{2} after the coal pile is placed into the furnace core (2), cover the fire gathering board (6), throw into the burning a few centimeters of paper strips or first throw the paper strips and then cover the fire gathering board (6), immediately began to zero smoke, orderly, long flame, full combustion, a few minutes to ten minutes, visible pilot coal (10) top red hot coal layer obviously down, clean combustion process can be consolidated
(14) the full combustion process of the pilot coal (10) and the lower coal (9) is burned first by the agricultural and forestry waste particles, other volatile components and nanoscale carbon in turn, at this time the red hot coal layer has a considerable number of microporous as a fixed carbon micro coal gasification reaction generator and combustion chamber, increasing the amount of gasification combustion, which is conducive to increasing the long flame combustion period; the gas continues to burn through the red hot coal seam as the ventilation holes (12) and (13) of the small combustion chamber; then through the large combustion chamber (7) to complete the full combustion; and finally in the main torch with the secondary air intake to supplement the combustion, through this 4-stage continuous combustion to achieve full combustion.

2. Item (iii) according to claim 1, characterized by the technical principle that: \textcircled{1} the low carbon atomic number of mixed alcohols includes 2-9 carbon atoms in general, with no restrictions on the structural isomerism of the carbon chain, the number of alcohol hydroxyl groups and the unclear properties; also include the use of ethanol alone with or without water, the use of isopropyl alcohol alone with or without water formulations, methanol, although similar technical effects and lower cost, can also be included, but because of its highly toxic, not advocated by the simple small micro-stoves customers use; these low carbon atomic number mixed alcohol molecules screened by the system have been initially oxidized compared to hydrocarbons with the same carbon chain structure, so they can achieve full combustion with zero smoke from the moment of ignition, \textcircled{2} the main consideration when formulating: the flash point, ignition point, melting point, volatility of various raw alcohols, there should be a gradient, in order to produce ignition paste and ignition cake (8) in the ignition of the combustion life of 2-3 minutes, to produce some recurring combustion effect, to extend the relatively high cost of the ignition agent is extremely valuable long flame combustion time, in order to quickly in the large combustion chamber (7) to produce 400-800° C. heat radiation and ignite the pilot coal (10), \textcircled{3} ignition paste and ignition cake (8) chemical composition have both hydrophilic and oleophilic properties, which is consistent with the pilot coal (10) and straw charcoal grille (11) performance, ignition gel soon melted due to heat, part of its upper straw charcoal grille (11) and the lower pilot coal (10) microporous adsorption at the same time, soon appear three-dimensional combustion, long flame combustion good situation, the formation of a large combustion chamber (7) high temperature area, so that the pilot coal (10) can be smooth and reliable zero smoke state ignition and rapid ignition long flame, therefore, the gel can completely replace the existing types of oxidizer on the ignition and make it industrially practical.

3. The remaining features of the ignition paste according to claim 1, item (iii), are: \textcircled{1} suitable for large size such as side length 25 cm column coal block, the number of combined units greater than 4 larger stoves, especially for continuous use, the chamber temperature such as chain grate boiler, its consumption can be significantly reduced, ignition costs reduced, but also to avoid the inconvenience of ignition cake (8) is too thin and easy to break, \textcircled{2} cold season cold stove ignition, can be squeezed into the ignition paste pilot coal (10) surface, immediately put on the straw charcoal grille (11) and then ignite, to ensure success on the ignition.

4. According to item (iii) of claim 1, characterized by: an example formulation of ignition paste (i.e. without limiting the type of raw materials and proportional parameters of the formulation only in this range) is—component a, isopropyl alcohol 46%, b, ethanol 20%, c, ethylene glycol 5%, d, calcium oleate 3%, e, magnesium oleate 1%, f, calcium stearate 3%, g, magnesium stearate 1%, h, water 21%, the main points of the production process (and not limited to its process parameters only) are—in 0.5 cubic meters of porcelain-jacketed anchor stirring reaction kettle, put a b c, turn on the stirrer, low speed, turn on the jacket steam slowly to 60° C., while gradually adding gelling agent d ef g in stages, to be completely dissolved into the paste agent after dissolving, slowly add the combustion rate inhibitor and gelling temperature and speed regulator h, turn off the steam, take a sample to test, paste point control is 46±2° C. in North China and 35±2° C. in Northeast China, continue to stir under alternate cooling-heating, keep at 55-60° C. and fill into 200-500 grams of PVC toothpaste tubes, screw cap sealing, natural cooling to normal temperature, 10 kg corrugated carton packaging into storage.

5. The remaining features of the ignition cake (8) according to item (iii) of claim 1 are: \textcircled{1} mainly applicable to the combination of the number of units below 4 small micro-stove, generally control for 4-5 mm thickness to meet the ignition requirements, straw charcoal grille (11) is added for auxiliary ignition, \textcircled{2} an example formula (i.e., without limiting the type of raw materials and proportion parameters of the formula only in this range) is—a, isopropyl alcohol 46%, b, ethanol 20%, c, ethylene glycol 5%, d, water 20%, e, sodium stearate 5%, f, magnesium stearate 3%, g, slaked lime 1%, \textcircled{3} the main points of the production process (and not limited to this) are—in the production of ignition paste in the same equipment, put a, b, c, turn on the lowest stirrer, turn on the jacket steam slowly rise in temperature, while adding gelling agent e, fin stages, the kettle material temperature to 60° C., reduce steam, after the liquid is almost transparent, slowly add the combustion speed inhibitor and gelation temperature speed regulator d, and finally sprinkle the supplementary hardener g, and allow the temperature to rise to 70° C., and take samples to determine the gelation temperature, which should be higher than 40° C.; keep the casting liquid at 50-60° C., cool to below 35° C., then demold and slice; use the least permeable polyvinyl acetate (cellophane) film bag among the common plastic films to encapsulate a single piece, and then set a polyethylene ultra-thin bag for every 10 pieces, and finally pack into a 5 kg corrugated carton for storage; it should be noted that the casting discharge pipe and pipe fittings must be well insulated to prevent condensation; the maximum allowable temperature of logistics is 38° C.; the production, logistics and use processes must comply with fire regulations.

6. A straw charcoal grille (11) according to item (iii) of claim 1 or characterized by: \textcircled{1} particularly suitable for use in combination with ignition cakes (8) or ignition paste to improve ignition reliability and reduce ignition costs when igniting small micro-stoves in cold weather, \textcircled{2} the main points of one formula and production process (i.e. not limited to this formula and process parameters) are as follows—add 100 kg of complete carbonized product of straw or other agricultural and forestry wastes with 10 mesh sieve, 15-20% of potassium water glass with a concentration of more than 2.8 modules, 6% of complete carbonized product in dry basis, and 3 kg of cooked lime powder to the mixing machine. and 3 kg of cooked lime powder, mix well and transfer into hydraulic molding machine to mold into straw charcoal grille (11), dry at 60° C. or below with large ventilation, and then pack into storage with ultra-thin plastic bags and corrugated cartons at two levels.

7. The pilot coal (10) according to claim 1, the remainder being characterized by: as an important lump of coal between the ignition paste and cake and the lower coal (9), the design of each group into a better state of assignment is further disclosed in substance, as well as \textcircled{1} the ignition point of each fuel component has a suitable gradient from low to high, mainly referring to agricultural and forestry waste, industrial waste wax, lost wax casting waste wax and waste stearic acid, waste polyolefin plastic, lignite, bituminous coal, coke surface, \textcircled{2} each component must also have a suitable particle size distribution according to the fineness, the particle size from small to large coke surface, bituminous coal, lignite, waste polyolefin plastic, agricultural and forestry waste particles, \textcircled{3} each component itself also has a reasonable particle size distribution, such as coke surface 80 mesh sieve all through, bituminous coal 30 mesh sieve all through, lignite 20 mesh sieve all through, all contain part of nano, micron particles; waste polyolefin plastic not less than 2 mm, containing a small amount of fine particles; agricultural and forestry waste particles less than 3 mm, containing a large number of fine powder, \textcircled{4} using potassium hydroxide liquid saponification of large-molecule organic acids, mainly refers to lignite, weathered coal, humic acid in grass peat (peat), fatty acids such as stearic acid in waste grease, rosin acid and longitudinal acid in larch; waste wax waste oil and emulsion generated by boiling saponification, mainly adsorbed by alkali cellulose particles formed by boiling agricultural and forestry waste particles, partly adsorbed by coal powder, large-molecule organic acid calcium salt and a small amount of potassium sodium salt with Large molecules of hydrocarbons, into a self-produced cheap coal powder organic binder, covering almost every coal powder particles, so that the coal cold and heat strength enough to meet the logistics and use requirements, and to reduce the ash content of coal, improve its formula calorific value, slow down the storage period calorific value reduction (drop card) is beneficial, \textcircled{5} the high volatile content of the formula refers to the volatile content of fossil fuels such as bituminous coal and lignite, plus the mass content of agricultural and forestry waste, waste plastics, and other large organic matter; the mass content of calcium potassium and sodium salts of large organic acids to meet the mechanical strength requirements of coal in the wet, hot and cold states is 8-12% of the pilot coal (10) moderately.

8. According to claim 1, the formula (it is not limited to the range of formula and process parameters), production process and packing points of a 100 mm small diameter column pilot coal (10) for heating, water boiling and medium to low temperature heating are shown below, \textcircled{1} dosing in dry base 200 g/pc, heat (5000-5300)×4.1868 kJ/kg is more appropriate, divided into two layers, two additions, one hydraulic molding, \textcircled{2} the recipe for each batch of 200 kg of product (containing 2-3% moisture down the line) (lower ingredient data in parentheses) is—a, pine sawdust 20 kg (15 kg) b, peanut shell powder 5 kg (9 kg) c, larch resin 9 kg (4.5 kg) d, lost wax casting waste wax waste stearic acid 9 kg (4.5 kg) e, potassium hydroxide 3.2 kg (1.6 kg) f, bituminous coal, low level heat 6000×4.1868 kJ/kg, volatile content 35%, 60 mesh screen all over 18 kg and 25 mesh screen all over 30 kg (heat grade as before, 25 mesh screen all over, 65.85 kg) g, calcium oxide powder 3.5 kg (5 kg), j, pigment iron red 0.3 kg (0.35 kg) h, 40% potassium water glass 5 kg (8 kg) i, water 40 kg (35 kg), \textcircled{3} the main points of the production process—in an open flat-bottomed iron pot with paddle stirrer add water, potassium water glass, larch, lost wax casting waste wax (containing a large proportion of waste stearic acid), heated to a boil and maintained for about 15 minutes, fishing out twigs leaves stones and other debris, put while filtering the saponification solution into the kneading pot with agricultural and forestry waste debris has been added, after 15-20 minutes of heat preservation and kneading, add the coal powder that has been evenly mixed with iron red and cooked lime, and potassium water glass to continue kneading for 10 minutes and then pushed to the hopper of hydraulic molding machine No. 1, this is the upper layer of the pilot coal (10); the other identical system is equipped with the lower layer of the pilot coal (10), which is pushed to the hopper of the hydraulic forming machine No. 2; turn on the hydraulic molding machine, push the calculated amount of No. 1 material and No. 2 material into the mold barrel in turn while it is hot, compress and shape at one time, and then transfer into the large low temperature large air extraction drying room while it is hot, dry the pilot coal (10) at 60° C. until the moisture is less than 5%, generally controlled at 2-3%, remove it, cool it naturally to below 35 degrees Celsius, then pack each pilot coal (10) in a thin polyethylene plastic bag and put it into a corrugated carton for storage, forming pressure is carefully adjusted according to product varieties and specifications, and the mechanical strength of the product in wet, hot and cold states, in order to meet the normal production, logistics and use process is not easy to break, to maintain the appropriate fluffiness, which is conducive to the ignition stage of rapid temperature rise and fixed carbon gasification reaction.

9. The remaining characteristic of the lower coal (9) according to claim 1 is that: \textcircled{1} after the formation of its upper end of the high-temperature area, it is easy to smoothly catch fire without risk, so the formula is very flexible, and the focus has shifted to the selection of inexpensive raw materials, \textcircled{2} example of a heating, heating products and production processes (its varieties, formulations, process parameters are by no means limited to this range) the main points are as follows: product design heat 4000×4.1868 kJ/kg, volatile content 40%—straw crushed grain 10%, pine sawdust 10%, polyolefin waste plastic crushed grain 5%, 20% potassium water glass 8%, bituminous coal powder (5500×4.1868 kJ/kg, volatile content 30%) 68%, calcium oxide powder according to equivalent, using 3 times the sulfur equivalent, pigment iron red 0.5%, water 5%, \textcircled{3} the fineness of 25 mesh bituminous coal powder, and moderate size of straw crushed particles, pine sawdust, polyolefin waste plastic crushed particles, measured into the mixer, after about 10 minutes of mixing, and then add measured calcium oxide powder and pigment iron red (has been 10 times the weight of coal powder, straw crushed particles and pine sawdust primary mix), continue to mix for a few minutes, spray into the bonding agent potassium water glass liquid, control the total moisture of the formula 6-8%, and then mixed A few minutes, moved into the hydraulic molding machine hopper, with greater than the pilot coal (10) molding pressure of 20-30% of the pressure molding, not dry, off the line directly into the warehouse, into the furnace use, the ash collection tank at the bottom of the furnace set box of water, heat evaporation of rising water is very favorable to the coal type fixed carbon gasification reaction.
